(19) United States
(12) Patent Application Publication
(10) Pub. No.: US 2005/0103711 A1
(43) Pub. Date: May 19, 2005

(54) Isolation of oleuropein aglycon from olive vegetation water

(76) Inventors: Wayne Emmons, Metairie, LA (US); Connie Guttersen, Napa, CA (US)

Correspondence Address: BURNS DOANE SWECKER & MATHIS L L P, POST OFFICE BOX 1404, ALEXANDRIA, VA, 22313-1404, US

(21) Appl. No.: 10/714,967

(22) Filed: Nov. 18, 2003

(51) Int. Cl. B01D 11/00

(52) U.S. Cl. 210/639; 210/634; 554/8; 554/20

(57) ABSTRACT

The present invention provides economical methods for collecting oleuropein aglycon from olive vegetation water, a routine byproduct in the manufacture of olive oil. The methods have the advantage of facilitating the collection of other valuable constituents of olive vegetation water, and furthermore render the olive vegetation water environmentally benign, and thus suitable for routine disposal.

### BACKGROUND OF THE INVENTION

It has been hypothesized that the use of olive oil as a significant source of dietary fat affords cardioprotection. The hypothesis derives, at least in part, from the association of the wide use of olive oil throughout the Mediterranean area with a low incidence of coronary heart disease and certain cancers, e.g., breast and colon, among populations in that area. Visioli, F. & Galli, C., Cardiovascular Reviews and Reports, pp. 389-392, 389 (July 2002).

The cardioprotective effect associated with the use of olive oil has been attributed to its high content of oleic acid, a monounsaturated fatty acid that constitutes 56%-84% of the total fatty acids in olive oil. Id. More recent evidence shows that the phenolic components of extra-virgin olive oil may play a role in the protection from coronary heart disease observed in the populations of the Mediterranean area. Among the phenolic components of olive oil are those categorized as complex, e.g., oleuropein (OE), and simple, e.g., the oleuropen derivative hydroxytyrosol (HT). Id.

The phenolic components are present in substantial quantities only in extra-virgin olive oil. The variety designated merely “olive oil” is virtually devoid of such phenolic compounds. Id. It is believed that the presence of the phenolics in the extra virgin oil, but not in merely olive oil, is attributable to the methods used in the extraction of the oil from the olives. These phenolic components of the extra virgin olive oil have been shown to possess potent and dose-dependent anti-oxidant activities and play an important role in enzyme modulation. Visioli & Galli, p. 390.

Another derivative of oleuropein, the aglycon, which is obtainable by oleuropein hydrolysis, is well known as a pharmacologically active molecule for its potential application as an antimicrobial agent in common olive tree diseases. Brante, R. et al., J. Agric. Food Chem., 49, 3198-3203 (2001).

The phenolic components also correlate with the pungent and bitter taste of the oil, reduction of the oxidative process of fruity flavored aromatic compounds, and the improvement of the olive oil shelf life. Rodis et al., J. Agric. Food Chem, 50, 596-601 (2002).

The phenolic compounds are either originally present in the olive fruit, or are formed during olive oil extraction. The phenolic compounds, once released or formed during processing of the olives, are distributed between the water and oil phases. Other phenolic constituents are trapped in the solid phase, also known as the “pomace.” Rodis et al., p. 596. The distribution of the phenolics between the water and oil is dependent on their solubilities in the two phases. Only a very minor amount of the phenolics enter the oil phase. In general, the concentration of phenolics in the olive oil ranges from 50 to 1,000 μg/g of oil depending on the olive variety. Id. This amount of antioxidant in the olive oil is 1%-2% of the available pool of antioxidants in the olive fruit. The rest is lost with the waste water (approximately 53%) and the pomace (approximately 45%) depending on the extraction system. Id. Consequently, the low partition efficients of most olive oil antioxidants result in a substantial loss of those components with the waste water during processing. Rodis et al. p. 600; see also Visioli, et al., J. Agric. Food Chem, 47, 3397-3401, (1991).

The substantial loss of such phenolics is attributable, at least in part, to the fact that a considerable amount of water is employed during the malaxation of extraction process. Malaxation is the continuous washing of the olive paste with warm water prior to the separation of the oil from the paste. The wash water, in addition to that endogenously contained in the olives, is separated from the olive oil and is referred to generally as “waste water” or Olive Vegetation Water (OVW). OVW is a complex emulsion that includes many potentially valuable components, e.g., oil, sugars, polyphenolics, and oleuropein and its various derivatives.

The OVW presents both opportunity and added costs to the olive oil production process. For example, OVW is a toxic and polluting residue for plants. Certain phenolic compounds within the OVW (e.g., hydroxytyrosol and other polyphenols) show phytotoxic activities for some crops. Soler-Rivas, C., et al., J. Sci. Food Agric, 80, 1013-1023 (2000). Many constituents of the OVW are resistant to biodegradation and are not readily decomposed. And many of those constituents contribute to the emulsion. Thus far, the industry has been unable to develop suitable end-of-pipe treatment technology, and the processing and disposal of OVW constitutes a significant burden on a mill's economy. Visioli et al., p. 3397 (1999).

Some of those phenolic compounds, however, are associated with potent antioxidant properties. Id. Thus, OVW has potential value as a source of phenolic antioxidants, and might also provide natural bactericidal agents for the protection of crops from pests and diseases. Id.

Among the most important constituents of OVW is oleuropein and its various derivatives; and, of those, perhaps the most significant is oleuropein aglycon (OA). Soler-Rivas et al., p. 1017-1018 (2000). OA shows potent antioxidant activity, and has a synergistic effect with other constituents of olive oil, e.g., tocopherols. Oleuropein and its various degradation products have also been shown to demonstrate in vitro bactericidal and bacteriostatic activities. Soler-Rivas et al., p. 1019 (2000). OA is the product of a hydrolysis reaction effected by naturally occurring enzymes; and the rate of the reaction, and the resulting quantity of OA, is affected by the processing conditions employed.

OA is increasingly the focus of commercial attention. Products containing oleuropein and its derivatives are on the market today. Many of those products originate from other sources, e.g., olive leaf, grape seed, and green tea. Further, such products contain mixtures of oleuropeins, and often result from inefficient and costly recovery processes. There remains a need for cost-effective processes for selectively collecting and purifying OA, and other potentially valuable constituents of OVW, and for preparing OVW for disposal.

### BRIEF DESCRIPITON OF THE DRAWINGS

FIG. 1 illustrates the deglycosylation of oleuropein glycoside to oleuropein aglycoside, which takes place through the action of naturally occuring enzymes.

FIGS. 2A and 2B are schematic illustrations of phase I and phase II of the oleuropein extraction and deglycosylation, as described more fully below.

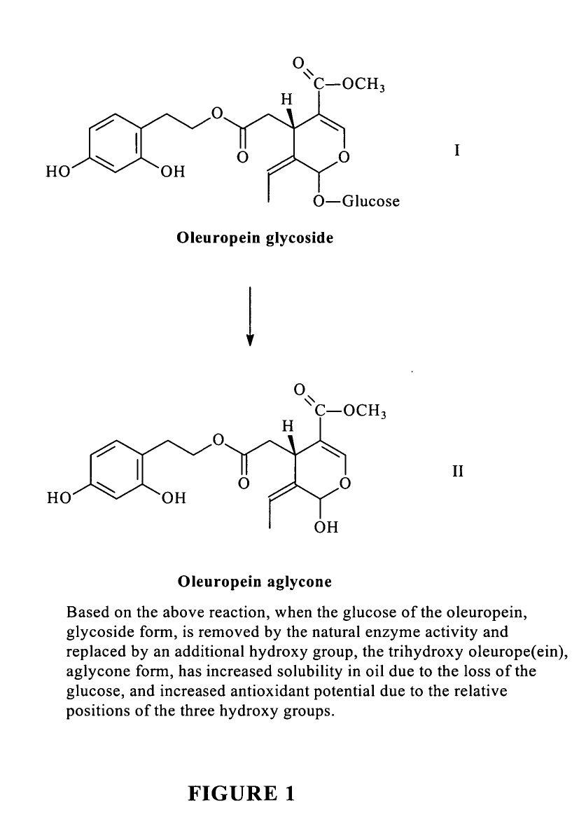

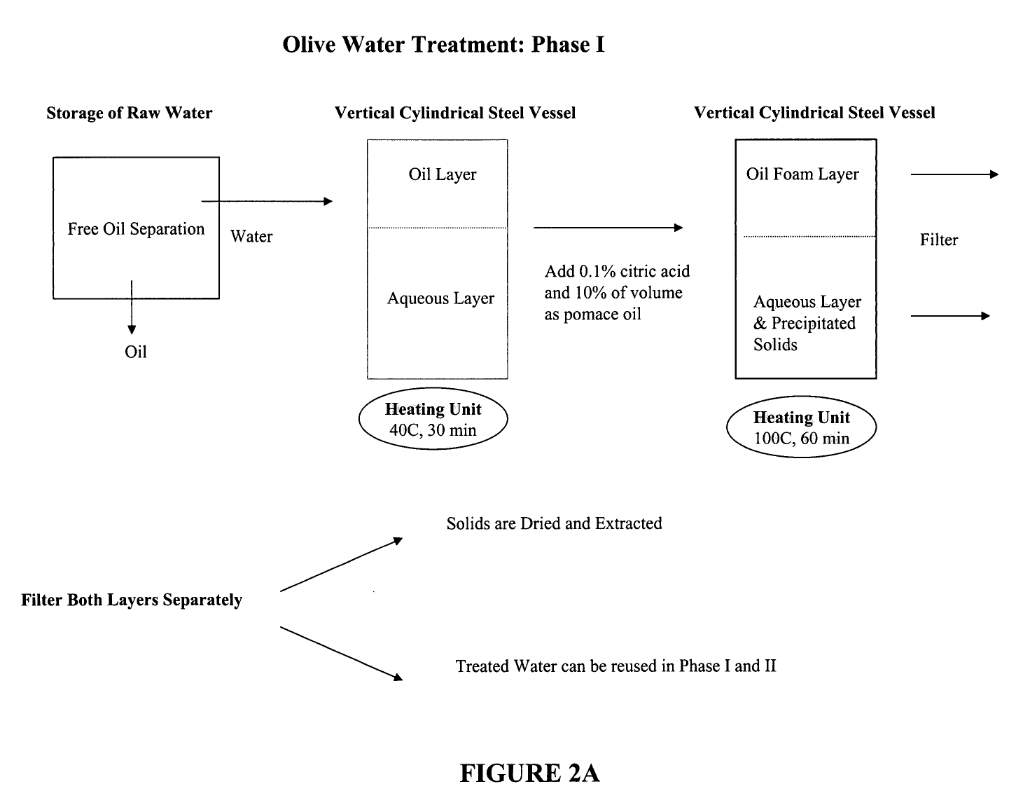

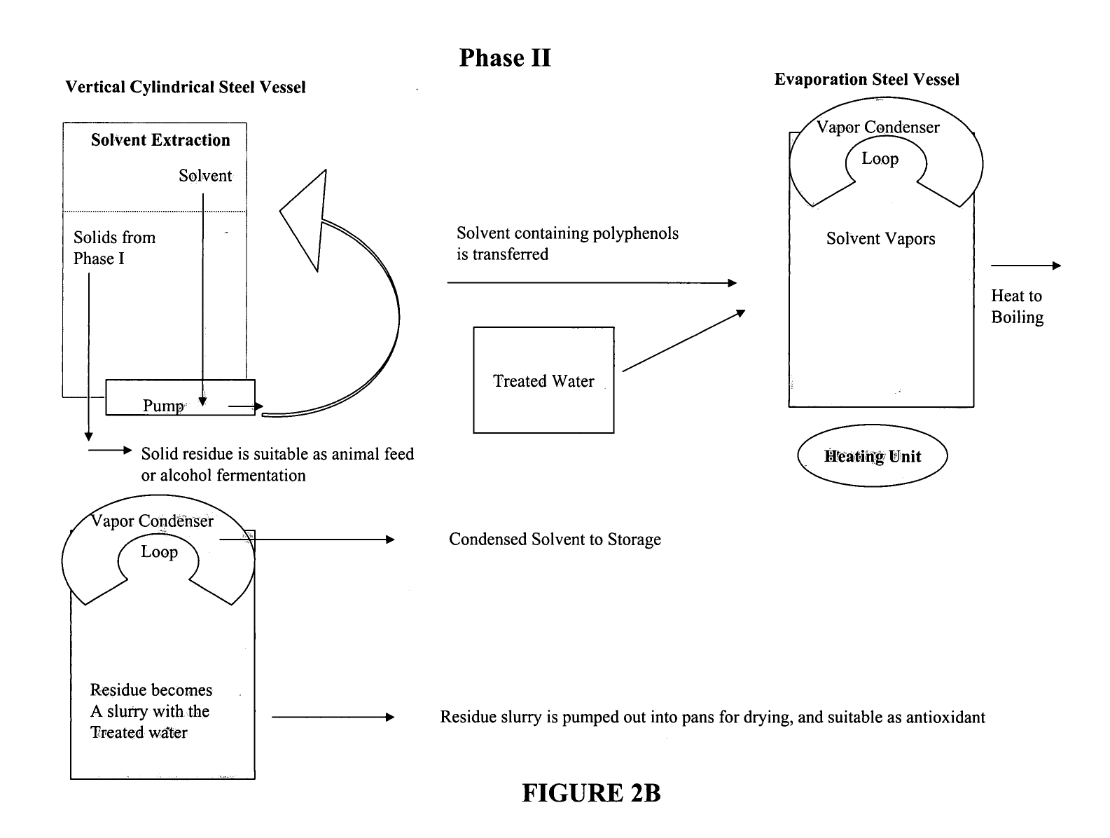

### DETAILED DESCRIPTION OF THE INVENTION

The instant invention provides methods for selectively removing and recovering oleuropein aglycon from OVW. In one embodiment, the method involves the following steps:
Obtaining raw OVW comprising oleuropein, oleuropein aglycon, and conversion enzymes;
Adding pomace oil to the raw OVW to concentrate oleuropein aglycon in a collection of floating solids;
Adding citric acid and heat to form precipitated solids;
Adding treated water to raw OVW to form additional precipitated solids and to increase oleuropein aglycon concentration;
Adding a solvent mixture (e.g., hexane and acetone) to extract the oleuropeins and further concentrate oleuropein aglycon; and
Adding treated water during a final evaporation stage to facilitate oil separation, solvent removal, and further increase the total level of oleuropeins extracted.
   The resulting OVW can be used for direct irrigation, or further treatment by conventional waste water processes.

For purposes of the present invention, the term “raw OVW” refers to an aqueous mixture containing a mixture of oleuropein, oleuropein aglycon, and any of the naturally occurring enzymes capable of hydrolyzing oleuropein to oleuropein aglycon (i.e., conversion enzymes). In preferred embodiments, the raw OVW will be the product derived from a water wash of olive vegetation matter as in the manufacture of olive oil. In such embodiments, raw OVW will comprise the water from a washing step as well as endogenous water removed from the olive vegetation matter.

The term “treated water” refers to raw OVW that has been processed to remove at least a portion of oleuropeins and oleuropein aglycon. Preferably, treated water will retain a substantial quantity of conversion enzymes.

The term “floating solids” refers to an oleuropein aglycon-rich collection of water-immiscible constituents that are less dense than water and tend to form or migrate to the surface of the OVW. The floating solids are often manifested as a foam on the surface of the OVW.

The term “precipitated solids” refers to water-immiscible constituents that are at least as dense as water. The precipitated solids will commonly comprise oleuropein and various sugars. In at least one embodiment of the present invention, those constituents are removed by filtration or centrifugation.

Phase I

The initial step to recover the polyphenolics, oleuropein aglycon and it's related compounds is to break the complex emulsion of the water. The initial step is to hold the olive vegetation water for 48 hours upon immediate production as a by-product of the olive oil or to by pass this holding phase and heat the water to 40° C. for 30 minutes in a vertical cylindrical steel vessel, preferably by steam.

During this heating step the oleuropein is hydrolyzed to the aglycon (OA) by natural enzymes present in the olive vegetation water. The OA rises to the surface as a constituent of a water immiscible foam that can be continually removed by surface skimming or other conventional methods.

The quantity of oleuropein aglycon can be increased in the floating foam by adding citric acid, olive pomace oil, and heat. Preferably, about 0.01% to about 1.0% citric acid is added; and more preferably, about 0.1% citric acid. Unless stated otherwise, all percentages are by weight. The olive pomace oil is preferably added in a quantity of about 2% about 20% of the raw OVW; and more preferably to a volume equal to about 10% of the volume of raw OVW.

Heat can also be exploited to increase the quantity of OA in the foam. In preferred embodiments, the temperature is increased to about 100° C. for about one hour. Lower temperatures can be used for correspondingly longer periods to achieve substantially the same effect. During this heating step, additional solids precipitate and are suspended in the aqueous layer. The precipitated, or suspended, solids are high in oleuropeins, sugars, and other components. Although not wishing to be bound by any theory, we believe that the higher level of oleuropeins gained from the addition of the olive pomace oil is due to the drying of the foam as it passes through the hot oil and because the oleuropein aglycon is more oil soluble than the other forms.

The floating solids on the top layer of the foam are removed by filtration or skimming, and the precipitated solids in the aqueous bottom layer can be removed by filtration or centrifugation. In a preferred embodiment approximately half of the resulting water is added to a second batch of raw olive vegetation water, and the extraction/treatment described above is repeated.

The final water from this second process is cleaner and more environmentally benign, and can be discharged as irrigation water or it can be disposed of by conventional water treatment methods.

During this second treatment process, a higher percentage of solids can be recovered thereby increasing the yield since a greater percentage of conversion enzymes accumulate. This process of keeping half of the volume of treated water and adding the other half of the volume from fresh olive vegetation water can be repeated as necessary or until all of the water produced is treated. The recovered solids can be dried, e.g., by heat or vacuum.

Phase II

In the second phase, the floating solids from the first phase are extracted by a mixture of solvents. Preferably, the collected floating solids are first dried before the extraction step is performed. Drying can take palce by air drying, under vacuum, with heat, or combinations thereof. Suitable solvents are non-polar organic solvents or mixtures of solvents. Non-polar organic solvents refers to organic solvents that are substantially immiscible with water, or those that are miscible with other organic solvents that are substantially immiscible with water. Exemplary solvents are alkanes (whether straight chain, branched, or cyclic), ethers, petroleum ethers, aromatic solvents and substituted aromatic solvents (e.g., benzene, toluene, xylene), polyols, and the like. Preferred solvents include pentane, hexane, heptane, acetone, ethyl acetate, diethyl ether, dimethyl furan, and mixtures thereof. It is further preferred that the solvent or solvent mixture has a boiling point lower than that of water (i.e., <100° C.). Especially preferred solvents include a mixture of hexane and acetone. Preferably, the hexane/acetone mixture is from about 40/60 (% by volume) to about 60/40; and more preferably about 50/50.

In preferred embodiments, there are two additional steps in the extraction process. First, the non-polar solvent or solvent mixture is contacted with the recovered solids. The vertical cylindrical steel vessel, used as the heating equipment in the first step, can be used in this step. In a preferred embodiment, the solvent is pumped into a tank, pumped out of the bottom, and then re-circulated through the top until the desired concentration of oleuropein to oleuropein aglycon is obtained. Preferably, the volume of solvent used is about one to three liters of solvent per kilogram solids, and more preferably, about two to one (l/kg).

In a second step, the solvent is removed. Solvent removal can be performed under vacuum, heat, or a combination thereof. Preferably, solvent removal is performed by transferring the oleuropein aglycon product of the above extraction step to a second vessel. The second vessel is preferably a stainless evaporation/vacuum vessel, but can be any vessel suitable for removing solvent from a mixture or solution. Generally, the solvent vapors coming off the mixture are routed through a loop and are cooled by water or an air cooler such that the condensed vapors are collected in a storage or collection vessel remotely from the oleuropein aglycon-rich mixture. This step of solvent removal is continued until the volume in the evaporation vessel is about one tenth the original volume.

At this time, previously treated water is added to the vessel as necessary to precipitate oil and facilitate the total removal of solvent. The vessel is reheated to boiling with the solvent traveling through the same condenser loop to the solvent storage until the vapor temperature exceeds the boiling point of the solvent. The condensate is then directed back to the holding tank for the raw treatment of water until the consistency of the residue in the evaporation tank is a slurry or a pumpable mud. The slurry residue, which does not contain any solvent, is then pumped into pans for drying by the same means as in the first stage. The resulting product is about 40% oleuropein aglycon as determined by HPLC. Remaining solids are natural olive solids.

The other remaining end products also have potential uses. For example, the solid residue from the extraction step is high in sugar and is a suitable supplement for animal feed or alcohol fermentation. (See Fig. II: Olive Water Treatment-Phase II; and Fig. III: Phase II)

1. A method for isolating oleuropein aglycon from raw olive vegetation water, said method comprising:
(a) adding citric acid and heat to the raw olive vegetation water;
(b) collecting an aqueous immiscible oleuropein aglycon-containing constituent from the aqueous mixture;
(c) extracting oleuropein aglycon from the aqueous immiscible constituent with a non-polar, organic solvent; and
(d) removing the solvent.

2. The method of claim 1, wherein the non-polar, organic solvent is a mixture of hexane and acetone.

3. The method of claim 1, wherein the non-polar, organic solvent is a mixture of hexane/acetone in a ratio of between about 60/40 (vol/vol) to about 40/60.

4. The method of claim 1, wherein the non-polar, organic solvent is a mixture of hexane/acetone in a ratio of about 50/50 (vol/vol).

5. The method of claim 1, wherein the citric acid is added to a concentration of about 0.1% (by weight).

6. A method for isolating oleuropein aglycon from raw olive vegetation water, said method comprising:
(a) adding about 0.01% to about 1.0% citric acid;
(b) adding about 10% (by volume) olive pomace oil;
(c) heating the mixture;
(d) collecting an aqueous immiscible oleuropein aglycon-containing constituent from the aqueous mixture;
(e) extracting oleuropein aglycon from the aqueous immiscible constituent with a non-polar, organic solvent; and
(f) removing the solvent.

7. The method of claim 6, wherein about 0.1% citric acid is added to the raw olive vegetation water.

8. The method of claim 6, wherein about 10% olive pomace oil is added to the raw olive vegetation water.

9. The method of claim 6, wherein the raw olive vegetation water is heated to about 100° C. for about one hour.

10. The method of claim 6, wherein the step of collecting an aqueous immiscible oleuropein aglycon-containing constituent from the aqueous mixture is followed by a drying step.

11. The method of claim 6, wherein the step of extracting oleuropein aglycon from the aqueous immiscible constituent with a non-polar, organic solvent is performed using a solvent mixture comprising about 40% (by volume) or more hexane.

12. The method of claim 6, wherein the extraction of step (e) is followed by a solvent removal step.

13. The method of claim 12, wherein the solvent removal step includes a step of adding treated water to an oleuropein aglycon-rich fraction from which solvent is being removed.
